(19) United States
(12) Patent Application Publication
(10) Pub. No.: US 2013/0158921 A1
(43) Pub. Date: Jun. 20, 2013

(54) LOAD IMPEDANCE DETECTION

(71) Applicants: Peter J. Shah, San Diego, CA (US); Arash Mehrabi, San Diego, CA (US)

(72) Inventors: Peter J. Shah, San Diego, CA (US); Arash Mehrabi, San Diego, CA (US)

(73) Assignee: QUALCOMM INCORPORATED, San Diego, CA (US)

(21) Appl. No.: 13/434,158

(22) Filed: Mar. 29, 2012

Related U.S. Application Data
(60) Provisional application No. 61/576,876, filed on Dec. 16, 2011.

(51) Int. Cl. G06F 19/00

(52) U.S. Cl. 702/65

(57) ABSTRACT

Techniques for determining the impedance of a load coupled to an amplifier. In an exemplary embodiment, a mirroring transistor is provided to mirror the current through a transistor of the amplifier output stage to a predetermined ratio. The impedance of the load may be calculated based on the mirrored current and the amplifier output voltage provided to the load. In an exemplary embodiment, the mirrored current may be digitized and provided to a digital load impedance calculation block, which estimates the load impedance based on the digitized current and an indication of the amplifier output voltage. Further techniques are described for calibrating the load impedance calculation scheme, and for differentiating between stereo and mono audio plugs using said techniques.

### CLAIM OF PRIORITY UNDER 35 U.S.C. §119

The present Application for Patent claims priority to Provisional Application No. 61/576,876 entitled “LOAD IMPEDANCE DETECTION” filed Dec. 16, 20122, and assigned to the assignee hereof and hereby expressly incorporated by reference herein.

### BACKGROUND

1. Field

The disclosure relates to load impedance detection, and, in particular, to techniques for determining the impedance of a load coupled to an amplifier output.

2. Background

In the art of electronic circuit design, amplifiers may often be designed to drive loads having indeterminate impedances. For example, an audio power amplifier may be required to drive headphones from a plurality of different manufacturers, and each type of headphone may have a different impedance. Furthermore, the impedance of any particular load may change over time, due to factors such as temperature, mechanical degradation, etc.

To optimize power delivery to a load by an amplifier, it would be desirable to determine the load impedance prior to driving the load. In audio applications, for example, this would prevent a headphone from being driven by an unsuitably high output voltage. There is accordingly a need to provide simple and robust techniques for accurately estimating the impedance of a load coupled to an amplifier output.

### BRIEF DESCRIPTION OF THE DRAWINGS

FIG. 1 illustrates a prior art audio amplifier system for illustrating the techniques of the present disclosure.

FIG. 2 illustrates an exemplary embodiment of an impedance detection scheme according to the present disclosure.

FIG. 3 illustrates an exemplary embodiment of a method according to the present disclosure.

FIG. 4 illustrates an alternative exemplary embodiment according to the present disclosure, wherein an additional switchable current source is provided for further calibration.

FIG. 5 illustrates an exemplary embodiment of a method for measuring load impedance according to the present disclosure.

FIG. 6 illustrates an exemplary embodiment of a mono/stereo differentiation scheme according to the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The detailed description set forth below in connection with the appended drawings is intended as a description of exemplary aspects of the invention and is not intended to represent the only exemplary aspects in which the invention can be practiced. The term “exemplary” used throughout this description means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein.

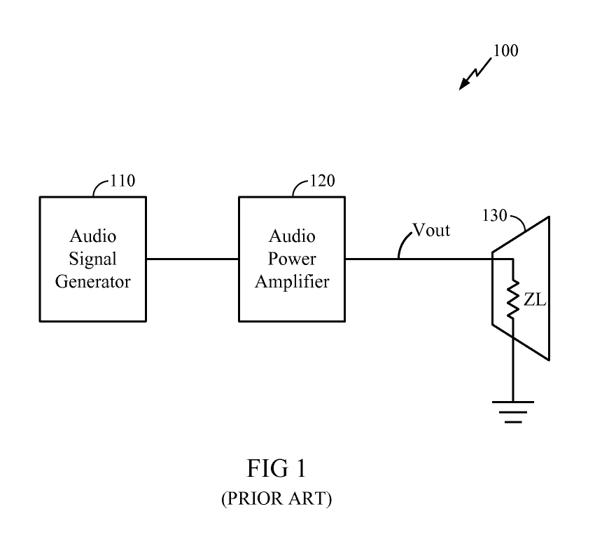

FIG. 1 illustrates a prior art audio amplifier system 100 for illustrating the techniques of the present disclosure. Note FIG. 1 is shown for illustrative purposes only, and is not meant to limit the scope of the present disclosure to audio systems, or to any particular configuration of an audio system. It will be appreciated that the techniques disclosed herein may also readily be applied to other types of systems, for example, systems employing RF amplifiers, etc. Such alternative exemplary embodiments are contemplated to be within the scope of the present disclosure. Note the audio system 100 may be, for example, a constituent component of any device configured to generate an audio output, for example, a mobile phone, a high-performance stereo system, etc.

In FIG. 1, an audio signal generator 110 generates an audio output signal for an audio power amplifier 120. In an exemplary embodiment, the audio signal generator 110 may include, for example, a codec, and one or more digital to analog converters (DAC's) (not shown) for converting a digital audio signal into an analog signal. It will be appreciated that alternative schemes for driving an audio power amplifier are known in the art, and are contemplated to be within the scope of the present disclosure

The audio power amplifier 120 may include, for example, one or more PMOS and/or NMOS power transistors to drive an audio load 130 having an impedance ZL (e.g., resistance) with an output voltage Vout. In an exemplary embodiment, the load 130 may correspond to an audio speaker, a headphone, etc. In general, the value of the load impedance ZL may be indeterminate, e.g., if the driven load is detachable from the amplifier. For example, the audio power amplifier 120 may be found in a mobile phone, and a headphone corresponding to the load 130 may be alternately attached to and detached from the mobile phone during use. Headphones from different manufacturers as adopted by a user will generally have different impedances, and thus the designer of the audio power amplifier 120 may not have a priori knowledge of the impedance of the headphone to be driven.

It will be appreciated that the effective acoustic pressure emitted from a headphone depends on the voltage applied to the headphone, as well as the impedance of the headphone. In order to achieve the same acoustic pressure from different headphones, it would be desirable to accurately determine the impedance of the headphone. Such headphone impedance information is also useful to keep the headphone output volume to within a comfortable range for the headphone user.

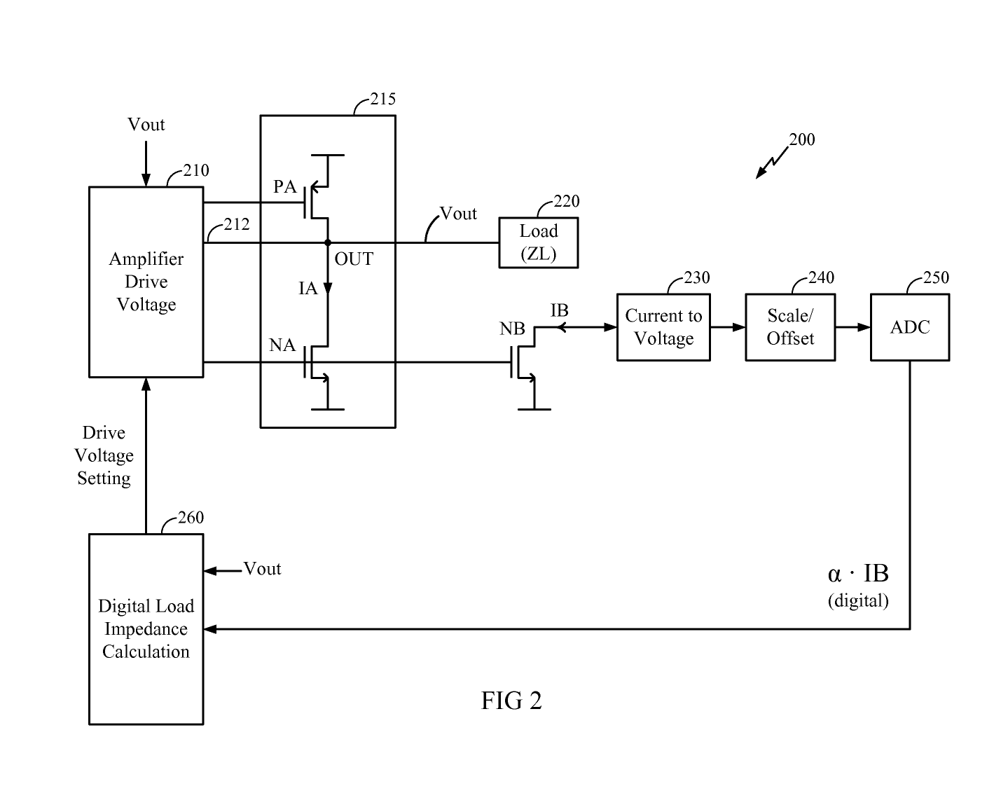

FIG. 2 illustrates an exemplary embodiment of a load impedance detection scheme 200 according to the present disclosure. Note the techniques illustrated in FIG. 2 are shown for illustrative purposes only, and are not meant to limit the scope of the present disclosure. For example, one or more functional blocks shown in FIG. 2 may be combined into a single block, as appropriate. Further note that the techniques shown in FIG. 2 need not be applied to an audio system, and may generally be applied to any application in which the impedance of an output load is to be measured. Such alternative exemplary embodiments are contemplated to be within the scope of the present disclosure.

In FIG. 2, an amplifier drive voltage block 210 generates drive voltages for transistors PA and NA, which correspond to PMOS and NMOS transistors, respectively, of a power amplifier 215. The output node OUT of the power amplifier 215 supports an output voltage Vout that is coupled to a load 220, which may have an unknown impedance ZL that is to be determined Note the node OUT may be coupled back to the block 210 via a feedback connection 212 to allow for appropriate biasing of the transistors PA and NA.

It will be appreciated that the drive voltages for PA and NA need not be the same, and that the drive voltages may generally drive the power amplifier according to any of various amplifier drive schemes known in the art, e.g., Class A, AB, B, etc. The techniques of the present disclosure are contemplated to be applicable to any of such amplifier drive schemes. Furthermore, it will be appreciated that the power amplifier 215 is shown for illustrative purposes only, and is not meant to limit the scope of the present disclosure to any particular transistor topology for a power amplifier.

In FIG. 2, the gate voltage of NA is coupled to the gate of a mirroring transistor NB. The current through mirroring transistor NB is configured to match that through NA to a fixed current ratio. For example, NB may have a current corresponding to (W/L)_{NB}/(W/L)_{NA} times that of the current through NA, wherein W/L is the width-to-length ratio of a transistor. It will be appreciated that to achieve the aforementioned mirroring function, various layout and/or design matching techniques known in the art of integrated circuit design may be applied to accurately configure, e.g., the W/L ratios, and hence the current ratios, between NA and NB. In this specification and in the claims, it will be appreciated that the term “mirror” is not meant to imply that two mirrored currents are necessarily of the same value, but rather that two mirrored currents are at a fixed predetermined ratio relative to one another.

Note while the mirroring transistor NB is shown provided for the NMOS transistor NA in FIG. 2, in alternative exemplary embodiments, a mirroring transistor and current measurement capability may be alternatively or additionally provided for the PMOS transistor PA. Furthermore, such mirroring and measurement capability may generally be provided for any of the driving transistors in the output stage of a power amplifier, including, for example, transistors of an output stage (not shown) utilizing one or more cascoded transistors. In this specification and in the claims, a “driving” transistor of a power amplifier will be understood to encompass any transistor that sources current to or sinks current from a driven load whose impedance is to be determined. Such alternative exemplary embodiments are contemplated to be within the scope the present disclosure.

The current IB through NB is provided to a current-to-voltage conversion module 230, which converts the current through NB to a voltage for further processing. In an exemplary embodiment, the module 230 may simply include a resistor coupled to a DC voltage. The converted voltage is coupled to an optional scale/offset module 240, which may apply scaling and DC offset to the converted voltage to make it more suitable for input to the analog-to-digital converter (ADC) 250. The digital output of the ADC 250 is provided to a digital load impedance calculation block 260. The block 260 may further accept as input an indication of the output voltage Vout of the power amplifier 215. Note Vout may be provided in digital form to the block 260 (e.g., following conversion by an ADC not shown in FIG. 2), or the block 260 may further incorporate an ADC (not shown) for digitizing Vout for further processing.

In an exemplary embodiment, the block 260 digitally estimates the impedance of the load 220, based on the digital output of ADC 250 and output voltage Vout, according to the techniques described hereinbelow. Where necessary, the block 260 may further provide a drive voltage setting to the amplifier drive voltage block 210 to set the drive voltages generated by the amplifier drive voltage block 210.

Techniques are further described hereinbelow for enabling the digital impedance calculation block 260 to calculate the impedance of the load 220. Note the techniques described herein are for illustrative purposes only, and are not meant to limit the scope of the present disclosure to any particular techniques for calculating impedance using the blocks shown in FIG. 2. One of ordinary skill in the art will appreciate, in light of the description of the scheme 200, that the impedance of the load 215 may also be derived using alternative techniques not explicitly described herein. Such alternative exemplary embodiments are contemplated to be within the scope of the present disclosure.

In an exemplary embodiment, the impedance ZL of the load 220 may be digitally calculated as follows (Equation 1):

ZL_calc=Vout/[α·IB·(NA/NB)];

wherein ZL_calc represents the digitally calculated load impedance, Vout is the output voltage of power amplifier 215, α is a scaling term accounting for gains introduced by the system (e.g., by the current to voltage conversion block 230, the scale/offset block 240, ADC 250, etc.), IB is the actual current in NB, and NA/NB is the current ratio between NA and NB. Note the term α·IB effectively corresponds to the output of ADC 250, as indicated in FIG. 2. It will be appreciated that Equation 1 effectively assumes that the entire current IA runs through the load 220, and utilizes Ohm's law to calculate the load impedance ZL. Thus Equation 1 may be applicable to those cases wherein no bias current is present in transistor NA.

In an alternative exemplary embodiment, to improve accuracy and/or cancel the effects of possible bias current in the PA output (e.g., quiescent current as may be present when the amplifier is driven according to a Class AB scheme) from the impedance calculation, two or more voltage-current (V-I) observations using varying drive voltages may be combined to yield a better estimate of the load impedance. For example, an indication of a first current IB1 through NB, corresponding to a first output voltage Vout1, may be measured at the output of the ADC 140. Subsequently, a second current IB2, corresponding to a second voltage Vout2 different from Vout1, may be measured. In an exemplary embodiment, the output voltage Vout may be set to the appropriate values by designing the digital load impedance calculation block 260 to configure the drive voltage settings of the amplifier drive voltage block 210. From Vout1 and Vout2, the load impedance may then be calculated as (Vout2−Vout1)/(IB2−IB1). It will be appreciated that, for improved accuracy, more than two voltage-current pairs may also be measured, and approximation techniques such as least squares may be utilized for estimating the load impedance.

It will be appreciated that, in certain implementations of a Class A, B, AB, or other type of power amplifier, the bias current may be considered as having either no signal dependence or negligible signal dependence. In an exemplary embodiment, Vout2 and Vout1 may be sufficiently separated in voltage so as to allow sampling of diverse data points, for more accurate estimation. In an exemplary embodiment, one of the multiple observations may set Vout equal to 0 Volts.

It will further be appreciated that the voltage-current (V-I) measurements may generally correspond to static DC measurements, or to time-varying values, e.g., sinusoids, as may be useful for determining complex load impedances.

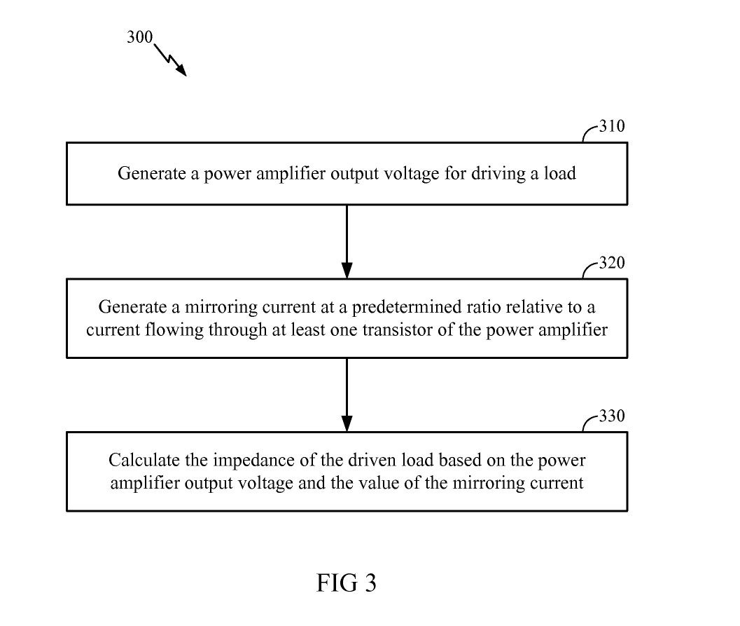

FIG. 3 illustrates an exemplary embodiment of a method 300 according to the present disclosure. In FIG. 3, at block 310, a power amplifier output voltage is generated for driving a load. At block 320, a mirroring current is generated at a predetermined ratio relative to a current flowing through at least one transistor of the power amplifier. At block 330, the impedance of the driven load is calculated based on the power amplifier output voltage and the value of the mirroring current.

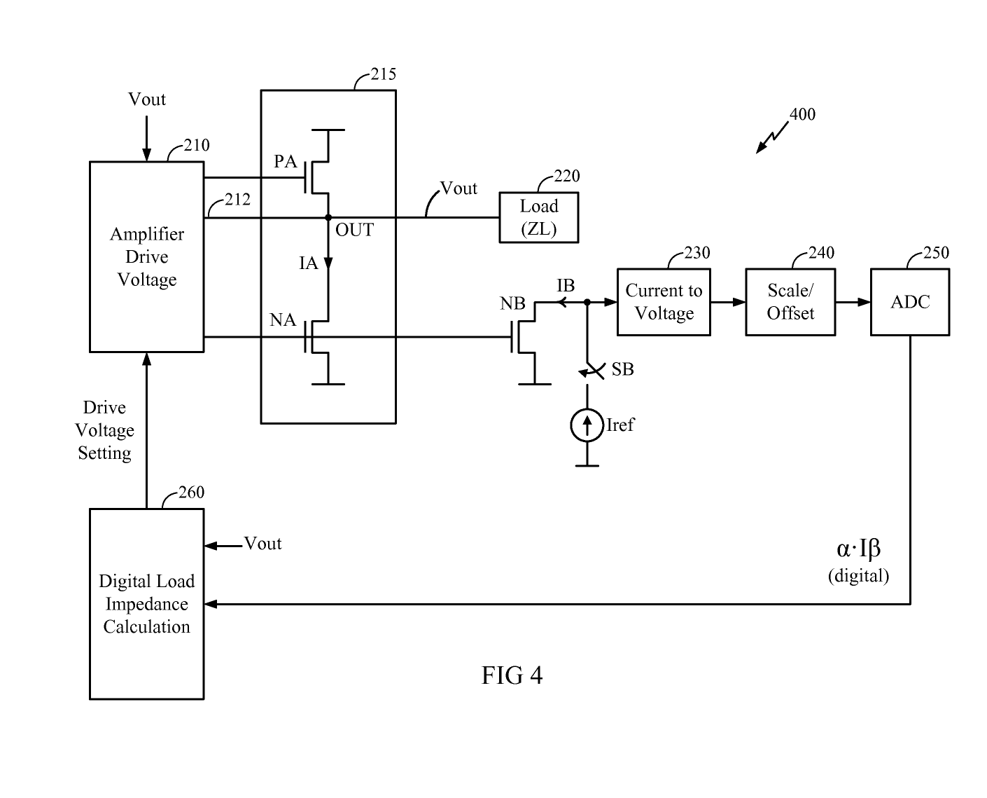

FIG. 4 illustrates an alternative exemplary embodiment according to the present disclosure, wherein an additional switchable current source is provided for further calibration. In FIG. 4, a switchable current source generating a known current Iref is selectively coupled in parallel with the drain of NB using a switch SB. In an exemplary embodiment, during a calibration phase of the load impedance measurement, a first voltage-and-current measurement (Vout1, IB1) may be made with the switch SB open. Subsequently, a second measurement (Vout1, IB2) may be made with the switch SB closed. Note in this case, the value of the voltage Vout at the power amplifier output is kept constant at Vout1 between the two measurements. As the current Iref is known a priori, the current IB2 through the current-to-voltage conversion module 230 is expected to be equal to the initial measured current IB1 plus the contribution from the known current Iref. It will be appreciated that by observing the output of the ADC for both measurements, non-idealities in the signal path arising from the current-to-voltage conversion module 230, scale/offset block 240, and/or the ADC 250 may be determined.

For example, it is expected that the output of the ADC corresponds to ADC(IB1) when SB is open, and ADC(IB1)+ADC(Iref) when SB is closed, wherein ADC(x) denotes the expected digital output of the ADC given a current x through the current-to-voltage module 230. Therefore, deviations of ADC(IB1+Iref) from ADC(IB1)+ADC(Iref) may be attributed to non-ideality (e.g., non-linearity) arising from the aforementioned signal path, and may be thus appropriately compensated for when performing the load impedance calculation.

It will be appreciated that, to better characterize the non-idealities in the signal path, the current Iref may be further swept over a range of multiple values, and corresponding ADC measurements may be made at each Iref. It will also be appreciated that Iref may further be selected as a value proportional to IB. For example, the current source Iref may be implemented as an auxiliary transistor mirroring the currents through NA and NB at a predetermined ratio. Such alternative exemplary embodiments are contemplated to be within the scope of the present disclosure.

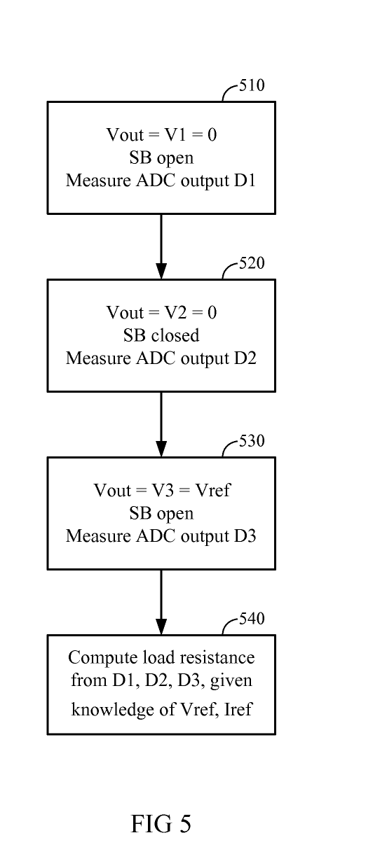

FIG. 5 illustrates an exemplary embodiment of a method for measuring load impedance according to the present disclosure. The method of FIG. 5 may be executed, for example, using the exemplary embodiment shown in FIG. 4.

In FIG. 5, at block 510, the power amplifier output voltage Vout is set to a first voltage (V1) equal to 0, corresponding to no expected current flow in the load. SB is kept open, and the ADC output D1 is measured.

At block 520, Vout is set to a second voltage (V2) also equal to 0. SB is closed, and the ADC output D2 is measured.

At block 530, Vout is set to a third voltage (V3) equal to a known reference level Vref. SB is opened, and the ADC output D3 is measured.

At block 540, the load impedance is calculated from the ADC outputs D1, D2, and D3, given knowledge of Vref and Iref. It will be appreciated that execution of blocks 510, 520, and 530 effectively determines three V-I data measurement points, and one of ordinary skill in the art may readily derive an estimated impedance for the load based on such data measurement points.

Note while an exemplary embodiment has been described wherein three data measurement points are determined, it will be appreciated that the techniques of the present disclosure may be readily applied to accommodate an arbitrary number of data measurement points, e.g., more data points for improved accuracy. Such alternative exemplary embodiments are contemplated to be within the scope of the present disclosure.

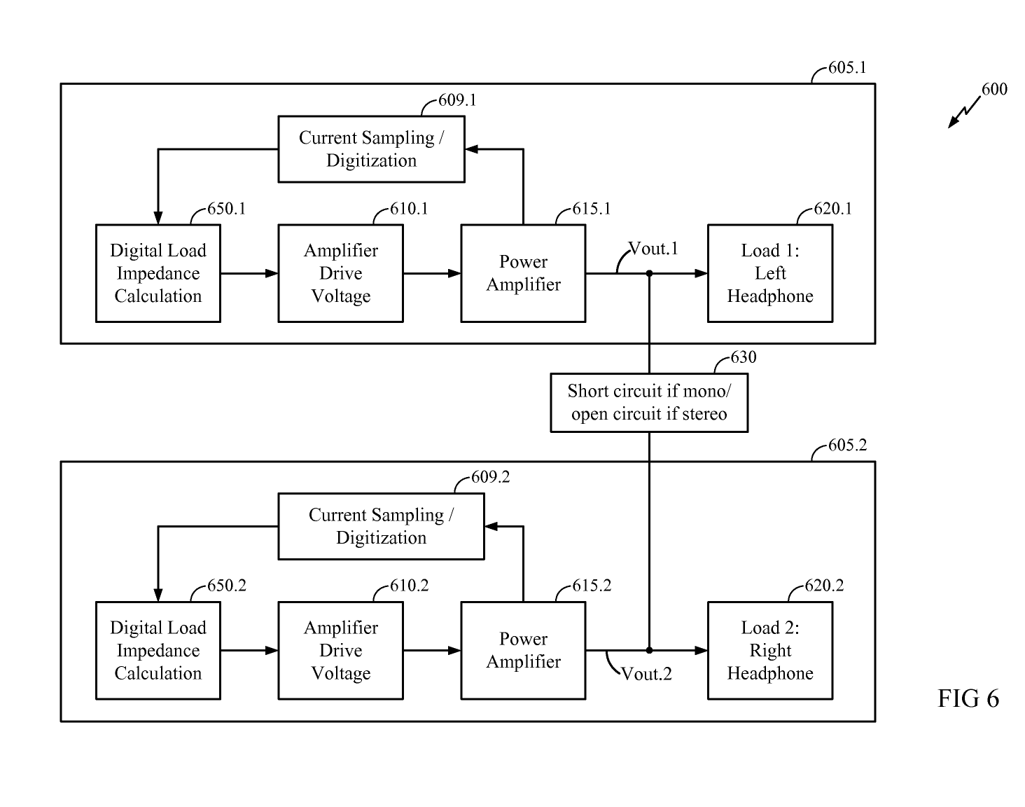

Note the aforementioned impedance detection techniques further enable a scheme for distinguishing between mono plugs and stereo plugs having left (L) and right (R) audio channels. FIG. 6 illustrates an exemplary embodiment 600 of a mono/stereo differentiation scheme according to the present disclosure. It will be appreciated that similarly denoted blocks in FIGS. 6 and 2 will be understood to perform similar functionality, unless otherwise noted.

In FIG. 6, a left channel driving block 605.1 and a right channel driving block 605.2 are shown. The left channel driving block 605.1 includes a digital load impedance calculation block 650.1, an amplifier drive voltage block 610.1, and a power amplifier 615.1 coupled to a first load 620.1, which may be a left audio channel headphone. For simplicity, the blocks corresponding to the current-to-voltage conversion block 230, the scale/offset block 240, and the ADC 250 in FIG. 2 are represented as a single current measuring/digitization block 609.1 for the left channel driving block 605.1 in FIG. 6. Note the right channel driving block 605.2 includes similar blocks coupled to a second load 620.2, which may be a right audio channel headphone.

In FIG. 6, a connection 630 is shown between the output voltage Vout.1 driving the first load 620.1 and the output voltage Vout.2 driving the second load 620.2. As indicated in FIG. 6, if the loads 620.1 and 620.2 correspond to the headphone channels of a mono headset, then the connection 630 is expected to be a short circuit. If, however, the loads 620.1 and 620.2 correspond to the headphone channels of a stereo headset, then the connection 630 is expected to be an open circuit. Given this information, the load impedance calculation techniques earlier described hereinabove may be readily applied to differentiate between a mono headset and stereo headset, as further described hereinbelow.

In an exemplary embodiment, an output voltage Vout1 may be applied to the load 620.1 at Vout.1, and an output voltage Vout2 may be simultaneously applied to the load 620.2 at Vout.2. The mirroring currents for each of the loads may be measured and digitized according to the techniques described hereinabove, for example, with reference to FIG. 2. Subsequently, the output voltage Vout1 may be kept constant for the load 620.1, but the output voltage for the load 620.2 may be changed from Vout2 to a different output voltage Vout3. The mirroring currents for each of the loads may again be measured and digitized. To determine whether the plug is stereo or mono, the following operations may be applied.

In particular, if the plug inserted is a stereo plug, then the mirroring current measurement for the load 620.1 should remain constant, regardless of whether the output voltage applied to load 620.2 changes from V2 to V3. This is because for a stereo plug, each of the channels may be independently driven without conflict, as noted with reference to the block 630. In the case of a mono plug, however, the mirroring current measurement for the load 620.1 will change when the output voltage applied to load 620.2 changes from V2 to V3. This is because for a mono plug, both the L and R channels are shorted together, such that attempting to apply different output voltages to the two channels will result in large current flow over the short circuit (as illustrated by block 630). Thus, by detecting any change in current delivered to the load 620.1, the scheme may differentiate between a stereo and a mono plug.

It will be appreciated that the designation of the first and second loads in FIG. 6 as “left” and “right” is arbitrary, and exemplary embodiments of the present disclosure may readily switch such designations as appropriate.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the exemplary aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary aspects of the invention.

The various illustrative logical blocks, modules, and circuits described in connection with the exemplary aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary aspects disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-Ray disc where disks usually reproduce data magnetically, while discs reproduce data optically with lasers. Combinations of the above should also be included within the scope of computer-readable media.

The previous description of the disclosed exemplary aspects is provided to enable any person skilled in the art to make or use the invention. Various modifications to these exemplary aspects will be readily apparent to those skilled in the art, and the generic principles defined herein may be applied to other exemplary aspects without departing from the spirit or scope of the invention. Thus, the present disclosure is not intended to be limited to the exemplary aspects shown herein but is to be accorded the widest scope consistent with the principles and novel features disclosed herein.

1. An apparatus comprising:
a power amplifier comprising at least one transistor, the power amplifier generating an output voltage for driving a load; and
a mirroring transistor having a fixed current ratio relative to the at least one transistor, the gates of the at least one transistor and the mirroring transistor being coupled to the same driving voltage;
wherein the impedance of the driven load is calculated based on the power amplifier output voltage and the current through the drain of the mirroring transistor.

2. The apparatus of claim 1, further comprising:
an analog-to-digital converter (ADC) configured to convert the current through the drain of the mirroring transistor to a digital value; and
a digital load impedance calculation block configured to calculate the impedance of the driven load based on the power amplifier output voltage and the digital value of the current.

3. The apparatus of claim 2, further comprising a current-to-voltage conversion module configured to convert the current through the drain of the replica transistor to a measured voltage, wherein the ADC is configured to convert the measured voltage to a digital value.

4. The apparatus of claim 3, further comprising a scale and offset block for scaling and adding an offset to the measured voltage prior to conversion to a digital value by the ADC.

5. The apparatus of claim 1, the at least one transistor comprising an NMOS transistor.

6. The apparatus of claim 3, the current-to-voltage conversion module comprising a resistor coupled to a DC voltage.

7. The apparatus of claim 2, the digital load impedance calculation block further configured to:
receive a first ADC digital value corresponding to the power amplifier output being driven to a first output voltage;
receive a second ADC digital value corresponding to the power amplifier output being driven to a second output voltage.

8. The apparatus of claim 7, the digital load impedance calculation block further configured to determine the impedance of the load by dividing the difference between the first and second voltages by the difference between the first and second ADC digital values.

9. The apparatus of claim 7, the first voltage corresponding to zero volts.

10. The apparatus of claim 1, further comprising a current source selectively coupleable to the drain of the mirroring transistor.

11. The apparatus of claim 2, the digital load impedance calculation block further configured to:
receive a first ADC digital value corresponding to the power amplifier output being driven to a first output voltage, and the current source being not coupled to the drain of the mirroring transistor;
receive a second ADC digital value corresponding to the power amplifier output being driven to the first output voltage, and the current source being coupled to the drain of the mirroring transistor;
receive a third ADC digital value corresponding to the power amplifier output being driven to a second output voltage, and the current source being not coupled to the drain of the mirroring transistor; and
determine the impedance of a load coupled to the power amplifier output based on the first, second, and third ADC digital values.

12. The apparatus of claim 2, further comprising an amplifier drive voltage block configured to drive the power amplifier output to a given output voltage in response to an indication from the digital load impedance calculation block.

13. The apparatus of claim 2, further comprising:
a second power amplifier comprising at least one transistor, the second power amplifier generating a second output voltage for driving a second load;
a second mirroring transistor having a fixed current ratio relative to said at least one transistor of the second power amplifier, the gates of the at least one transistor and the second mirroring transistor being coupled to the same driving voltage;
a second analog-to-digital converter (ADC) configured to convert the current through the drain of the second mirroring transistor to a digital value;
wherein the second power amplifier is configured to drive the second load successively with a first driving voltage and a second driving voltage while the power amplifier is simultaneously configured to drive the load with a constant voltage, and the digital load impedance calculation block is configured to determine whether the digital value of the measured voltage changes in response to the output voltage of the second power amplifier being changed.

14. The apparatus of claim 1, the power amplifier comprising a PMOS transistor, the mirroring transistor having a fixed current ratio relative to the PMOS transistor.

15. An apparatus comprising:
a power amplifier comprising at least one transistor, the power amplifier generating an output voltage for driving a load;
means for mirroring and measuring the current through the at least one transistor; and
means for calculating the impedance of the driven load based on input from the means for mirroring and measuring.

16. The apparatus of claim 15, further comprising means for digitizing the measured current through the at least one transistor, the means for calculating comprising means for digitally calculating the impedance of the driven load.

17. A method comprising:
generating a power amplifier output voltage for driving a load;
generating a mirroring current at a predetermined ratio relative to a current flowing through at least one transistor of the power amplifier; and
calculating the impedance of the driven load based on the power amplifier output voltage and the value of the mirroring current.

18. The method of claim 17, further comprising digitizing the mirroring current to generate a digital value, the calculating the impedance comprising being based on the digital value of the mirroring current.

19. The method of claim 18, further comprising:
measuring a first digital value corresponding to the power amplifier output being driven to a first output voltage;
measuring a second digital value corresponding to the power amplifier output being driven to a second output voltage; and
computing the impedance of the load by dividing the difference between the first and second voltages by the difference between the first and second digital values.

20. The method of claim 18, further comprising:
measuring a first digital value corresponding to the power amplifier output being driven to a first voltage;
measuring a second digital value corresponding to the power amplifier output being driven to the first voltage while further combining a reference current with the mirroring current such that the measured voltage includes both the mirroring current and the reference current;
measuring a third digital value corresponding to the power amplifier output being driven to a second voltage; and
calculating the impedance of the load based on the first, second, and third digital values.
